(19) United States
(12) Patent Application Publication
(10) Pub. No.: US 2004/0024708 A1
(43) Pub. Date: Feb. 5, 2004

(54) Remittance management system, a settlement management system, a remittance management method, a settlement management method and a computer program thereof

(75) Inventors: Kazuo Masuda, Tokyo (JP); Masayo Saegusa, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: MITSUBISHI CORPORATION, Tokyo (JP)

(21) Appl. No.: 10/621,323

(22) Filed: Jul. 18, 2003

Related U.S. Application Data
(63) Continuation of application No. PCT/JP02/00309, filed on Jan. 18, 2002.

(30) Foreign Application Priority Data
Jan. 19, 2001 (JP) 2001-12480

(51) Int. Cl. G06F 17/60

(52) U.S. Cl. 705/42

(57) ABSTRACT

In order to reduce the burden of the work or the remittance service charge, a remittance management system for managing a remittance performed by a client from a remitter account at a first financial institution to a remittee account at a second financial institution, includes a deposit confirming unit for confirming that money has been transferred from the remitter account to the first account at the first financial institution managed by the remittance management system and a remitter changing unit for changing the remitter by ordering to remit money from the second account at the second financial institution managed by the remittance management system to the remittee account instead of a remittance from the first account to the remittee account caused by a deposit to the first account.

The present patent application is a continuation application of PCT application No. PCT/JP02/00309 filed on Jan. 18, 2002, which claims priority from a Japanese patent application No. 2001-12480 filed on Jan. 19, 2001, the contents of which are incorporated herein by reference.

### BACKGROUND OF THE INVENTION

1. Field of the Invention

The present invention relates to a remittance management system, a settlement management system, a remittance management method, a settlement management method and a computer program thereof, wherein it is possible to reduce the total service charge and the remittance amount between a plurality of the banks.

2. Description of the Related Art

Generally, a bill for the goods or services is settled through an account with any financial institution such as a bank. In the conventional method, a client has remitted money to each bank for each transaction. For this reason, the client had to pay the service charge for each remittance, so the burden of the work accompanying the remittance was heavy. And also, the burden of the remittance service charge was big. The method for reducing such burden of the work or the remittance service charge depended only on the effort of the client within the range of her or his business.

### SUMMARY OF THE INVENTION

Therefore, it is an object of the present invention to provide a remittance management system, a settlement management system, a remittance management method, a settlement management method and a computer program thereof, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a remittance management system for managing a deposit and/or a withdrawal in regard to accounts at a plurality of financial institutions, while managing a remittance performed by a client from a remitter account at a first financial institution to a remittee account at a second financial institution, the remittance management system includes a deposit confirming unit for confirming that money has been transferred from the remitter account to the first account at the first financial institution managed by the remittance management system and a remitter changing unit for changing the remitter by ordering to remit money from the second account at the second financial institution managed by the remittance management system to the remittee account instead of a remittance from the first account to the remittee account caused by a deposit to the first account.

The remittance management system may further include a notifying unit for notifying the client of remitting money from the remitter account to the first account, wherein the client desires to remit money from the remitter account at the first financial institution to the remittee account at the second financial institution.

The remittance management system may further include a remittee changing unit for increasing an amount of the remittance between the first account and the second account by changing a part or all of a remittance from the second account to the first account and a part or all of a remittance from the first account to the remitter account each other, wherein the deposit confirming unit further manages a deposit to the second account, and the remitter changing unit further orders to remit money from the first account to the remittee account instead of a remittance from the second account to the remitter account caused by a deposit to the second account.

The remittance management system may further include a classifying unit for classifying remittances according to terms taking a remittance designation date or a remittance due date for a criterion, wherein the remittee changing unit changes a remittance classified as the same term by the classifying unit.

The remittance management system may further include a service charge database for storing a remittance service charge in regard to the plurality of financial institutions, a reduction amount calculating unit for calculating a reduced amount of the remittance service charge in case a plurality of remittances is adjusted to one remittance using the service charge database, a cost setting unit for calculating a cost for adjusting the plurality of remittances to one remittance using the service charge database, and a remittance composing unit for comparing the reduced amount of the remittance service charge to the cost based on the deviation of an interest, and adjusting the plurality of remittances to a single remittance when the reduced amount of the remittance service charge is more than the cost.

The remittance management system may further include an interest rate database for storing a loan interest rate and a deposit interest rate of the plurality of financial institutions, a service charge database for storing a remittance service charge in regard to the plurality of financial institutions, a reduction amount calculating unit for calculating a reduced amount of the remittance service charge in case a plurality of remittances, of which the remittance designation dates are different from each other, is adjusted to one remittance using the service charge database, an interest deviation calculating unit for calculating a deviation of interest rate caused by adjusting the plurality of remittances to the one remittance, using the interest rate database, a cost setting unit for calculating a cost for adjusting the plurality of remittances to one remittance using the service charge database and a remittance composing unit for comparing the reduced amount of the remittance service charge to the cost based on the deviation of the interest rate and adjusting the plurality of remittances to a single remittance when the reduced amount of the remittance service charge is more than the cost.

The remittance management system may further include a notifying unit for notifying and confirming the client of adjusting the plurality of remittances to the one remittance.

The remittance management system may further include a notifying unit for allowing the client to recognize a result of comparing the reduced amount of the remittance service charge to the cost, wherein the remittance composing unit adjusts the plurality of remittances to the one remittance, after receiving an order to adjust the plurality of remittances to the one remittance from the client.

The remittance management system may further include an interest rate database for storing a loan interest rate and a deposit interest rate of the plurality of financial institutions, a service charge database for storing a remittance service charge in regard to the plurality of financial institutions and a ordering unit for ordering the accounts at the plurality of financial institutions to supply money so that a cost for supplying money can be minimized using the interest rate database and the service charge database, in case a deposit balance of the second account is insufficient for a remittance amount to the remittee account.

The ordering unit may select an account, of which the remittance service charge from other the account to the second account is cheapest, and order the selected account to remit money to the second account, in case the remittance service charge from the selected account to the second account is lower than an interest charge for a loan in the second account, or order the second account to borrow, in case the remittance service charge from the selected account to the second account is higher than or equal to the interest charge for the loan in the second account.

The remittance management system may further include a remittance offsetting unit for offsetting a deposit amount from the remitter account to the first account by a remittance amount from the account managed by the remittance management system to the remitter account, wherein the deposit confirming unit manages the remittance from the account managed by the remittance management system to the remitter account.

According to the second aspect of the present invention, a remittance management system for managing remittances between at least two financial institutions, includes a remittance database for managing a remitter financial institution at which a remitter account exists, a remittee financial institution at which a remittee account exists and an amount of the remittance for each remittance, a service charge database for storing remittance service charge data in regard to within the same financial institution and between different financial institutions and a remittee changing unit for changing remittees of a plurality of remittances in regard to at least a part of the amount of the remittance so that a total amount of the remittance service charge can be lowered.

The remittee changing unit may increase the amount of the remittance in the remitter financial institution by changing a part or all of a remittance to the remitter financial institution and a part or all of a remittance from the remitter financial institution each other, in case there is a remittance to the remitter financial institution each other.

The remittance management system may further include a classifying unit for classifying remittances according to terms taking a remittance designation date for a criterion, wherein the remittee changing unit changes remittees of a plurality of remittances classified as the same term by the classifying unit.

The remittance management system may further include a reduction amount calculating unit for calculating a reduced amount of the remittance service charge in case remittees of two of remittances, of which the remittance designation dates are different from each other, are changed each other, an interest deviation calculating unit for calculating a deviation of interest rate for adjusting the remittees of two of remittances each other and a cost setting unit for calculating a cost for changing the remittees of two of remittances each other, wherein the remittee changing unit changes the two remittees each other, in case of judging that the reduced amount of the remittance service charge is more than a sum of the interest charge and the cost.

According to the third aspect of the present invention, a settlement management system for managing a settlement of a client, includes a monetary value registered in electrical devices generating unit for crediting the client with a monetary value registered in electrical devices, in case there is proof of cash and a deposit or in case there is no proof of cash and a deposit, a monetary value registered in electrical devices database for managing the monetary value registered in electrical devices for each client and an moving unit for allowing the client to settle a debt by moving the monetary value registered in electrical devices of the client managed by the monetary value registered in electrical devices database to other client according to an order of the client.

According to the fourth aspect of the present invention, a remittance management method for managing a remittance from a remitter account at a first financial institution to a remittee account at a second financial institution, includes the steps of confirming that money has been transferred from the remitter account to the first account at the first financial institution managed by a remittance management system and remitting money from the second account at the second financial institution to the remittee account and notifying the client of a result of the remittance, instead of a remittance from the first account to the remittee account caused by a deposit to the first account.

According to the fifth aspect of the present invention, a remittance management method for managing remittances between at least two financial institutions, includes the steps of managing remittance service charge data in regard to within the same financial institution and between different financial institutions, managing a remitter financial institution at which a remitter account exists, a remittee financial institution at which a remittee account exists and an amount of the remittance for each remittance and changing remittees of a plurality of remittances in regard to at least a part of the amount of the remittance so that a total amount of the remittance service charge can be lowered, finishing the remittance and notifying the client of a result of the remittance.

According to the sixth aspect of the present invention, a settlement management method for managing a settlement of a client, includes the steps of crediting the client with a monetary value registered in electrical devices, both in case there is proof of cash and in case there is no proof of cash, managing the monetary value registered in electrical devices for each client, allowing the client to settle a debt by moving the managed monetary value registered in electrical devices of the client to other client according to an order of the client and notifying the client of the finish of the settlement.

According to the seventh aspect of the present invention, a computer program for managing a remittance performed by a client from a remitter account at a first financial institution to a remittee account at a second financial institution, includes a deposit confirming module for confirming that money has been transferred from the remitter account to the first account at the first financial institution managed by a remittance management system and a remitter changing module for changing the remitter by ordering to remit money from the second account to the remittee account instead of a remittance from the first account to the remittee account caused by a deposit to the first account.

According to the eighth aspect of the present invention, a computer program for managing remittances between at least two financial institutions, includes a remittance managing module for managing a remitter financial institution at which a remitter account exists, a remittee financial institution at which a remittee account exists and an amount of the remittance for each remittance and a remittee changing module for changing remittees of a plurality of remittances in regard to at least a part of the amount of the remittance so that a total amount of the remittance service charge can be lowered.

According to the ninth aspect of the present invention, a computer program for managing a settlement of a client, includes a monetary value registered in electrical devices generating module for crediting the client with a monetary value registered in electrical devices, both in case there is proof of cash and in case there is no proof of cash and an moving module for allowing the client to settle a debt by moving the monetary value registered in electrical devices of the client to other client according to an order of the client.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is the block diagram illustrating the use of the remittance management system as the first example of the present invention.

FIG. 2 is the block diagram showing the configuration of the remittance management system.

FIG. 3 shows an example of the remittance database.

FIG. 4 shows an example of the service charge database.

FIG. 5 shows an example of the cost database.

FIG. 6 and FIG. 7 are the flowcharts showing the process of the remittance management system and client terminal.

FIG. 8 is the flowchart showing the detailed process of the step S200 shown in FIG. 7.

FIG. 9 is the block diagram showing the hardware configuration of the remittance management system.

FIG. 10 is the block diagram depicting the schematic operation of the remittance management system, which is the second embodiment of this invention.

FIG. 11 is the block diagram depicting an example of the configuration of the remittance management system.

FIG. 12 is an example of the remittance database.

FIG. 13 is an example of the interest rate database.

FIG. 14 is the flowchart depicting an example of the process of the remittance management system.

FIG. 15 is the flowchart explaining the process in S410 of FIG. 14 in detail.

FIG. 16 is the block diagram showing the use of the settlement management system as the third example according to the present invention.

FIG. 17 is the block diagram depicting the components of the settlement management system.

FIG. 18 shows an example of the monetary value registered in electrical devices database.

FIG. 19 is the flowchart demonstrating an example of process of the settlement management system.

FIG. 20 is the block diagram showing the schematic configuration of the remittance management system as the fourth example of the present invention.

FIG. 21 shows an example of the configuration of the interest rate database.

FIG. 22 is the flowchart showing an example of the process of the ordering unit.

FIG. 23 shows the schematic configuration of the remittance management system as the fifth example of the present invention.

FIG. 24 is the flowchart showing an example of the detailed process of the remittance management system corresponding to the step S200 shown in FIG. 7 in regard to the remittance management system.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

1. First embodiment

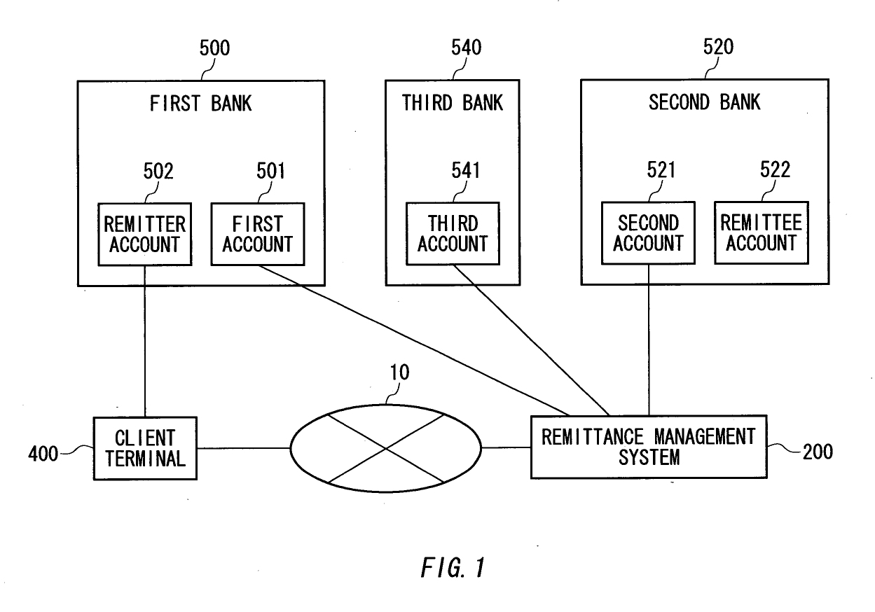

FIG. 1 is the block diagram illustrating the use of the remittance management system 200 as the first example of the present invention. In the present embodiment, the remittance management system 200 is coupled to the client terminal 400 via The Internet 10, and it manages the first account 501 of the first bank 500 as the financial institution, the second account 521 of the second bank 520 and the third account 541 of the third bank 540.

Moreover, the client having the client terminal 400 manages the remitter account 502 in the first bank 500. The remitter account 502 may be a general account or an account of the Internet banking. That is, the client terminal 400 directly or indirectly manages the remittance account 502.

If the client remits money from the remitter account 502 to the remittee account 522, the remittance management system 200 allows the client to remit money from the remitter account 502 to the first account 501 of the same bank and instead of the client remits money from the second account 521 to the remittee account 522 of the same bank so that it lowers the remittance service charge.

Here, both the remitter account 502 and the remittee account 522 may be more than one. Moreover, the accounts managed by the remittance management system 200 may exist in further banks. And, instead of the banks 500, 520 and 540 accounts of a savings and loan association or a post office may be used.

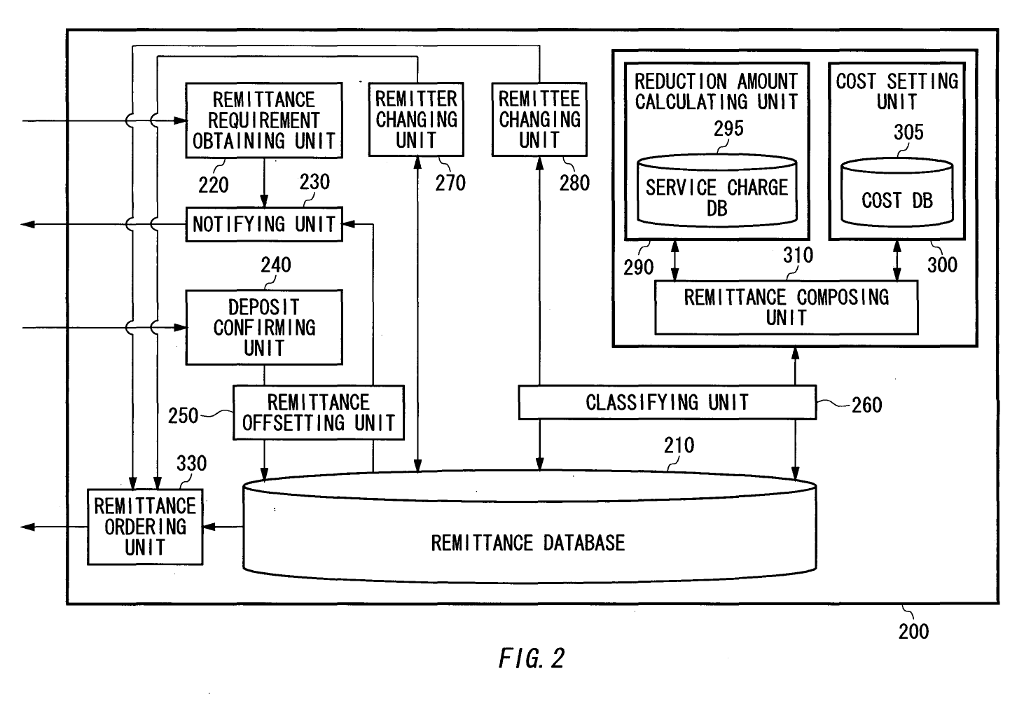

FIG. 2 is the block diagram showing the configuration of the remittance management system 200. The remittance management system 200 has a remittance database 210 as database, and it has a remittance requirement obtaining unit 220, a notifying unit 230, a deposit confirming unit 240, a remittance offsetting unit 250, a classifying unit 260, a remitter changing unit 270, a remittee changing unit 280, a reduction amount calculating unit 290, a cost setting unit 300, a remittance composing unit 310 and the ordering unit 330. Moreover, the reduction amount calculating unit 290 has a service charge database 295, and the cost setting unit 300 has the cost database 305.

The remittance database 210 is a database for storing data in regard to the remittance related to the client, namely, the data in regard to the deposit and the withdrawal.

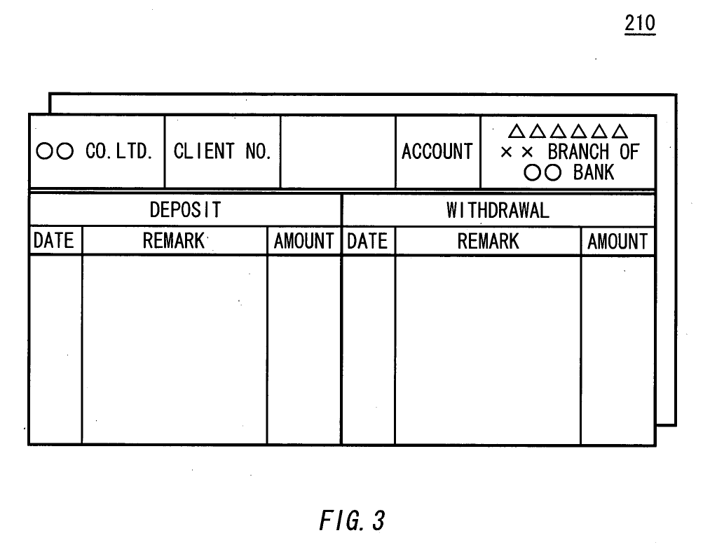

FIG. 3 shows an example of the remittance database 210. In the present embodiment, the remittance database 210 has tables for each client. Each table has a client name field, a client number field, an account field, a deposit field and a withdrawal field.

The account field stores the information specifying the account of the client such as the names of banks or branches and the account numbers.

Both deposit field and the withdrawal field have a date field, a customer field and an amount field. The date field stores the information specifying the date when the deposit or the withdrawal is done. The customer field stores the information specifying the remitter or the remittee. The amount field stores the deposit amount or the withdrawal amount.

Returning to FIG. 2, the remittance requirement obtaining unit 220 obtains the request for the remittance and the information specifying the account of the remittee from the client terminal 400, and it sends the request and the information to the notifying unit 230. The information specifying the account of the remittee may be, for example, account numbers.

The notifying unit 230 recognizes the account of the client based on the information from the remittance requirement obtaining unit 220 using the remittance database 210, and it sends the information specifying the account managed by the remittance management system 200 in the same bank as the account of the client, such as the account number or the information notifying the client of the deposit to the account, to the client terminal 400.

The deposit confirming unit 240 receives the information about the deposit and the withdrawal of the first account 501, the second account 521 and the third account 541, which are managed by the remittance management system 200, from the first bank 500, the second bank 520 and the third bank 540. Here, in the information received by the deposit confirming unit 240, the information specifying the date, the amount of deposit or withdrawal and the remitter or the remittee such as the account number are included. Moreover, the deposit confirming unit 240 stores the received information in the remittance database 210 via the remittance offsetting unit 250.

The remittance offsetting unit 250, if there is a remittance from the first account 501 to the remitter account 502, sends the information indicating the reduction of the deposit amount from the remitter account 502 to the first account 501 by about the extent of the remittance to the client terminal 400 via the notifying unit 230.

Moreover, the remittance offsetting unit 250 checks the information received from the deposit confirming unit 240, and sends the received information to the remittance database 210, in case the remittance from the first account 501 to the remitter account 500 and the remittance to the first account 501 become the amount of the remittance to the remittee account 522.

The classifying unit 260 classifies information retrieved from the remittance database 210 as terms taking the remittance designation date or the remittance due date for a criterion and sends the information to the remittee changing unit 280, the reduction amount calculating unit 290, the cost setting unit 300 and the remittance composing unit 310. Here, the classifying unit 260 set the term to be a day or a week, but the term is not always fixed.

The remitter changing unit 270, if the client remits money to the first account 501 in order to remit money from the remitter account 502 to the remittee account 520, sends the order to remit money from the second account 521 to the remittee account 520 to the ordering unit 330, instead of the remittance from the first account 501 to the remittee account 520. Moreover, the remitter changing unit 270 sends the order to remit money from the first account 501 to the remitter account 502 to the ordering unit 330, instead of the remittance from the second account 521 to the remitter account 502 caused by remitting to the second account 521.

The remittee changing unit 280 manages the remittance between the first account 501, the second account 521 and the third account 541 based on the remittance classified as the same term by the classifying unit 260. Here, the remittee changing unit 280 increases the amount of the remittance between the first account 501 and the second account 521 so that the number of times of the remittance can be reduced by changing a part of all of the remittance from the first account 501 to the second account 521 and a part of all of the remittance the second account 521 to the first account 501 each other.

The reduction amount calculating unit 290, if there is a plurality of remittances from the second account 521 to the remittee account 522 among the remittances classified as the same term by the classifying unit 260, calculates the reduced amount of the service charge for adjusting the plurality of remittances to one remittance. Here, in calculating the reduced amount of the service charge, the service charge database 295 is used.

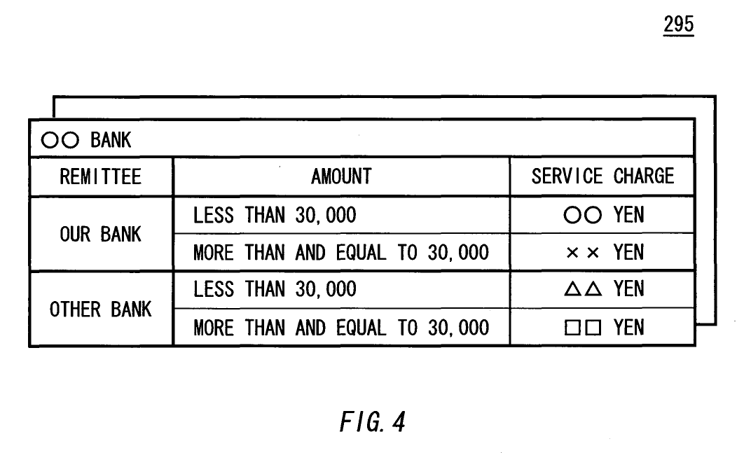

FIG. 4 shows an example of the service charge database 295. In the present embodiment, the service charge database 295 manages the remittance service charge for each bank. For example, the service charge database 295 manages the remittance service charge by classifying the remittance service charge by whether or the remittee is our bank or other bank and the amount of money.

That is, the reduction amount calculating unit 290 can calculates the difference between the total charge for remitting money separately and the charge for adjusting the plurality of remittances to one remittance using the service charge database 295. Moreover, the reduction amount calculating unit 290 sends the reduced amount, which is calculated, to the remittance composing unit 310.

Returning to FIG. 2, the cost setting unit 300, if there is a plurality of remittances from the second account 521 to the remittee account 522 among the remittances classified as the same term by the classifying unit 260, sets the cost for adjusting the plurality of remittances to one remittance using the cost database 305.

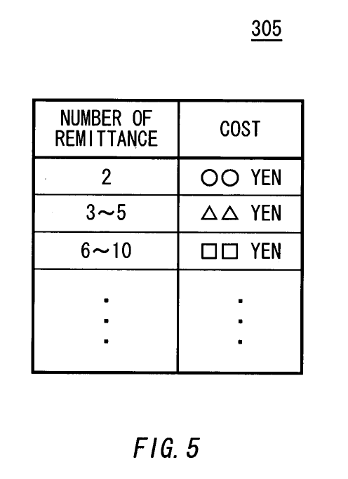

FIG. 5 shows an example of the cost database 305. In the present embodiment, the cost database 305 stores the number of the remittance adjusted to one remittance and the cost for adjusting the plurality of remittances to one remittance in order that the number corresponds to the cost respectively. Therefore, the cost setting unit 300 can set the cost for adjusting the plurality of remittances to one remittance retrieving from the cost database 305 by checking the number of the remittance to be adjusted to one remittance.

Moreover, the cost setting unit 300 sends the calculated cost to the remittance composing unit 310.

Returning to FIG. 2, the remittance composing unit 310 compares the reduced amount calculated by the reduction amount calculating unit 290 to the calculated cost and renews the remittance database 210 by adjusting the plurality of remittances to one remittance in case the reduced amount is larger than the cost.

The ordering unit 330 orders the remittance to the first account 501, the second account 521 and the third account 541 according to the data in the remittance data base 210. Moreover, the ordering unit 330 also orders the remittance between the first account 501, the second account 521 and the third account 541 according to the order from the remittee changing unit 280.

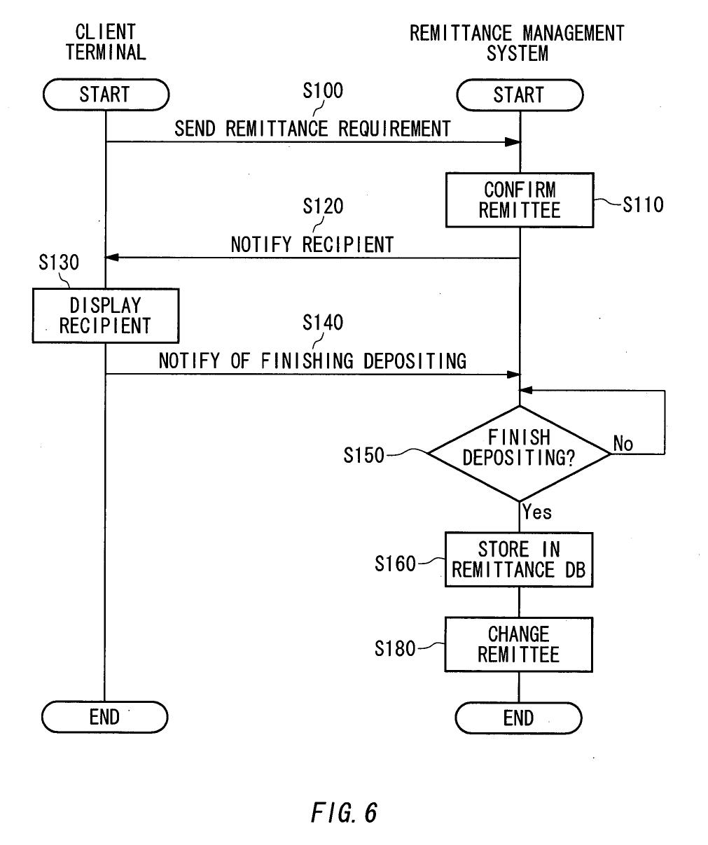

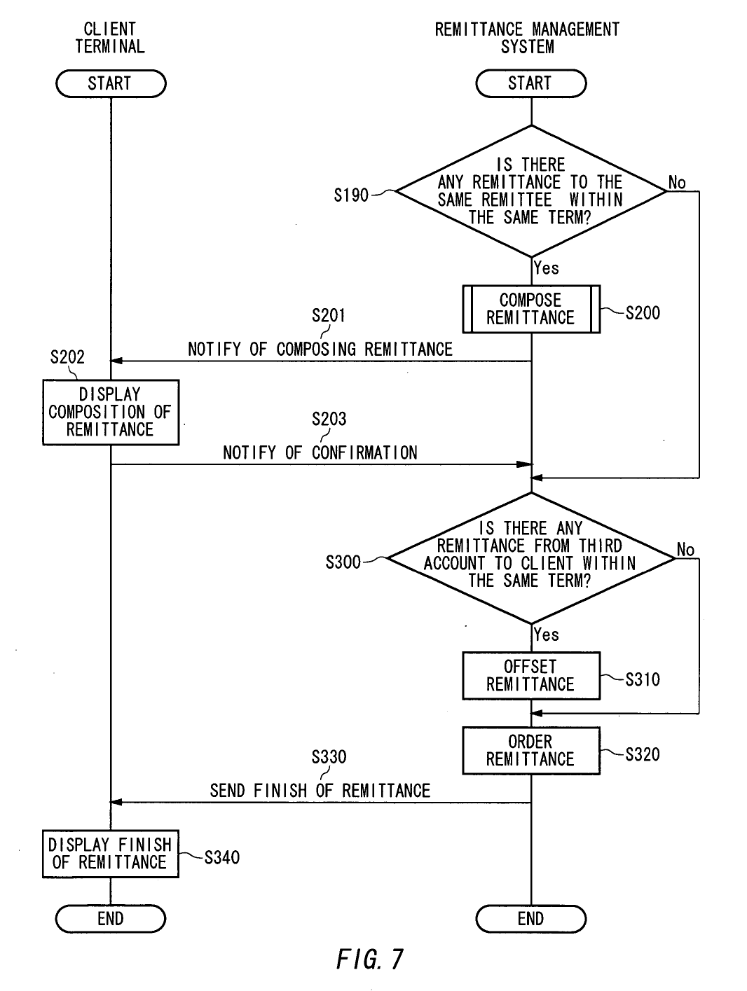

FIG. 6 and FIG. 7 are the flowcharts showing the process of the remittance management system 200 and client terminal 400. The client terminal 400 sends the information including the request of the remittance and the amount of the remittance (S100). When the remittance management system 200 receives the information from the client terminal 400, it confirms the remittee (S110) and notifies the client terminal 400 of the recipient using the notifying unit 230 (S120). In the present embodiment, the notified remittee is the first account 501. The client terminal 400 displays the recipient when it receives the notification (S130). Then, the client terminal 400 sends the notification of the finish of the remittance to the remittance management system 200 when the remittance is finished (S140).

Then, the remittance management system 200 confirms whether or not the remittance is practically done through the first account 501 (S150). The remittance management system 200, when confirming the remittance, stores a predetermined data (S160). Then, the remittance management system 200 changes the source of the remittance from the remitter account 502 to the second account 521 (S180).

As shown in FIG. 7, the remittance management system 200 confirms whether or not there is any other remittance to be done from the second account 521 to the remittee account 522 among the remittances classified as the same term by the classifying unit 260 (S190). If there is any other remittance to be done from the second account 521 to the remittee account 522, the remittance management system 200 composes the remittance using the remittance composing unit 310, the reduction amount calculating unit 290 and the cost setting unit 300, and it notifies the client terminal 400 of the composition of the remittance (S201). Here, the notified information, in addition to the result of comparing the reduced amount of the service charge to the cost due to the remittance composition, includes the information indicating the remittance due to the composition is different, if so, from the intention of the client.

Then, the client terminal 400 displays the notification of the remittance composition (S202) and sends the notification of accepting of the client for the remittance composition (S203).

When the remittance management system 200 receives the notification of the acceptance from the client terminal 400, it orders the remittance to the second account 521 using the ordering unit 330 (S300). Then, the remittance management system 200 sends the information indicating the finish of the remittance to the client terminal 400 (S330) and finishes the process.

Moreover, when the client terminal 400 receives the information indicating the finish of the remittance from the remittance management system 200, it displays the information (S340) and finishes the process.

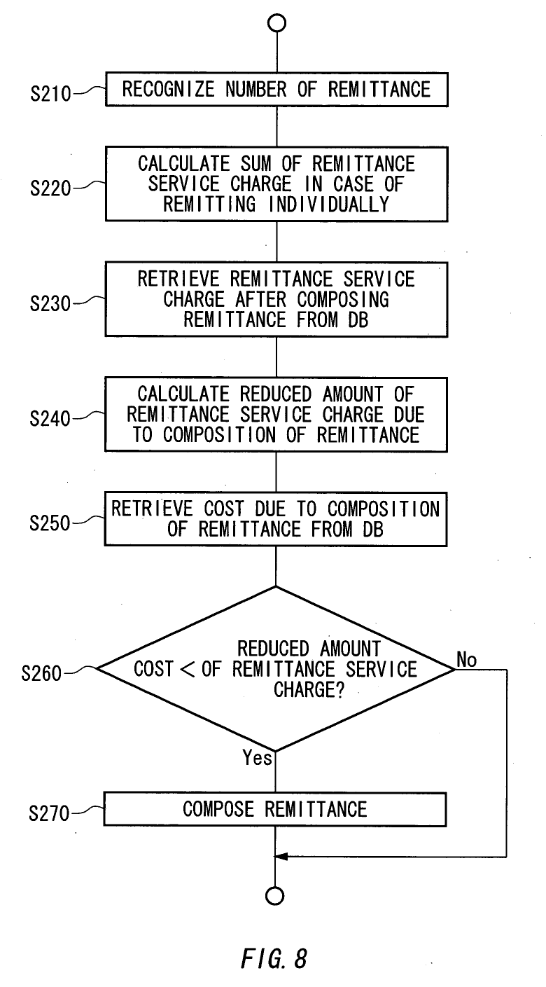

FIG. 8 is the flowchart showing the detailed process of the step S200 shown in FIG. 7. First, the remittance management system 200 recognizes the number of the remittance to be composed, namely, the number of the remittance from the second account 521 to the remittee account 522 classified as the same term (S210) Then, the remittance management system 200 calculates the sum of the remittance service charges for remitting money separately using the reduction amount calculating unit 290 (S220), while calculating the remittance service charge for composing the remittance (S230), and it calculates the reduced amount of the remittance service charge due to the remittance composition by calculating the difference (S240).

Next, the remittance management system 200 retrieves the cost for the remittance composition from the cost database 305 (S250).

Then, the remittance management system 200 compares the cost for the remittance composition to the reduced amount of the remittance service charge using the remittance composing unit 310 (S260). If the reduced amount of the remittance service charge is larger than the cost, the remittance management system 200 composes the plurality of remittances to one remittance (S270) and renew the remittance database 210 according to the composition.

Therefore, by using the remittance management system 200, it is possible to reduce the amount of the remittance between a plurality of banks. Hence, the remittance service charge the client has to pay becomes lowered. Moreover, the burden of the bank work accompanying the remittance becomes small.

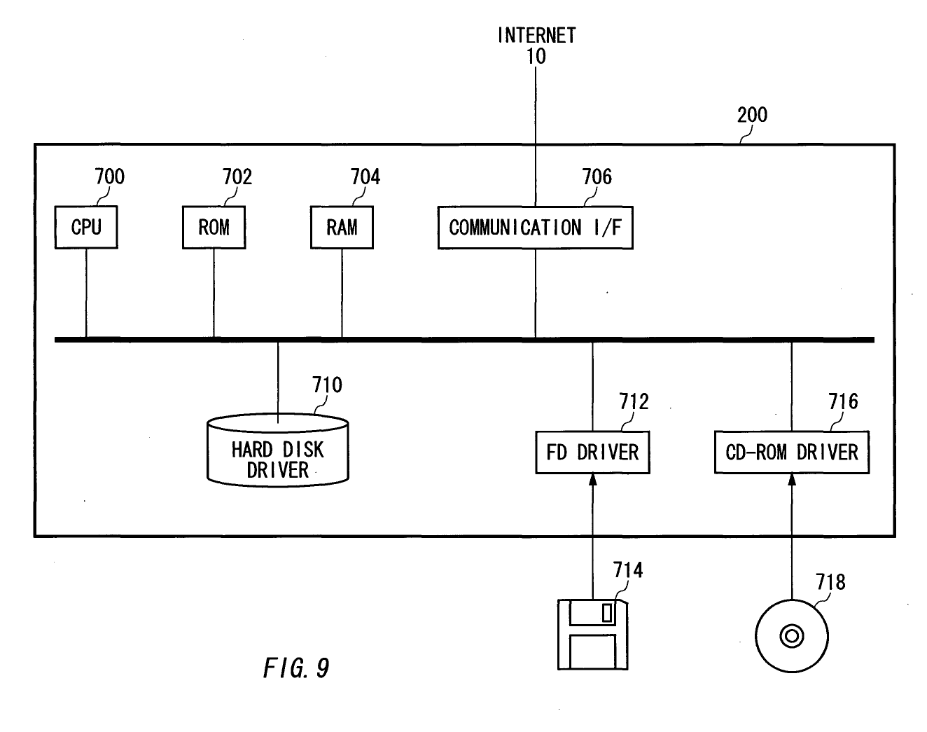

FIG. 9 is the block diagram showing the hardware configuration of the remittance management system 200. The remittance management system 200 includes a CPU 700, a ROM 702, a RAM 704 and a communication interface 706. The CPU 700 operates based on the program stored in the ROM 702 and the RAM 704. The communication interface 706 communicates with the exterior through the Internet 10. A hard disk driver 710 is an example of the memory, and it stores the setting information and the program, which drives the CPU 700.

A floppy-disk driver 712 reads the data or the program from a floppy disk 714 and provides it to the CPU 700. A CD-ROM driver 716 reads the data or the program from a CD-ROM 718 and provides it to the CPU 700. The communication interface 706 receives and sends the data through the Internet 10.

The software executed by the CPU 700 is provided to the user being stored in the floppy disk 714 or the CD-ROM 718. The software stored in the recording medium may be compressed or not. The software is installed in the hard disk driver 710 and executed by the CPU 700 being stored in the RAM 704.

The software provided being stored in the recording medium, namely, the software installed in hard disk driver 710 includes a remittance requirement obtaining module, a notifying module, a deposit confirming module, a remittance off setting module, a classifying module, a remitter changing module, a remittee changing module, a reduction amount calculating module, a cost setting module, a remittance composing module and a remittance ordering module.

The process, which these modules allows the CPU 700 to perform, with respect to the remittance management system 200 according to the present embodiments will not be described, because it is similar to the function and the process of the corresponding units.

The floppy disk 714 or the CD-ROM 718 shown in FIG. 9 can stores a part or all of the process or the function of the remittance management system 200 with respect to every embodiment described in the present application.

The program may be read from the recording medium and stored in the RAM or it may be installed in the hard disk driver and executed being stored in the RAM. Furthermore, the program may be stored in one recording medium or may be stored in a plurality of media. Moreover, the modules stored in the recording medium may be functioning along with the operating system. For example, the modules may request the operating system to perform the part or all of the function of them and be functioning based on the response from the operating system.

As the recording medium in addition to the floppy disk and the CD-ROM, the optical recording medium such as DVD, the magnetic recording medium such as MD, the magnetic and optical recording medium such as PD, the tape medium, the magnetic recording medium, the semi conductor memory such as the IC card or the miniature card can be used. Moreover, the program can be provided to the remittance management system 200 through the communication network by using the memory such as the hard disk or the RAM installed in the server system coupled to the leased line or the Internet as the recording medium.

Since the recording medium is used in order to manufacture the remittance management system 200, it is evident that manufacturing or selling the recording medium for the business purpose infringes the patent based on the present application.

2. Second Embodiment

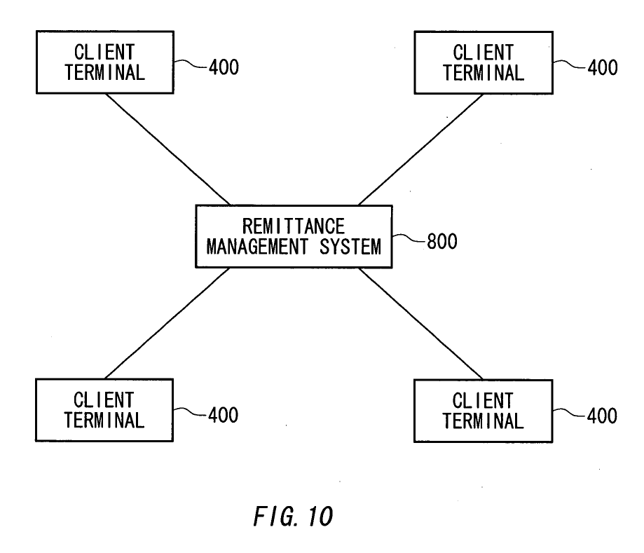

FIG. 10 is the block diagram depicting the schematic operation of the remittance management system 800, which is the second embodiment of this invention. The remittance management system 800 is a system managing the remittance between a plurality of banks, and it changes the remittee of a plurality of the remittances with at least some part of the remittance amount, so that the total amount of the service charge can be lowered.

The remittance management system 800 is coupled to a plurality of client terminal 400 through the Internet.

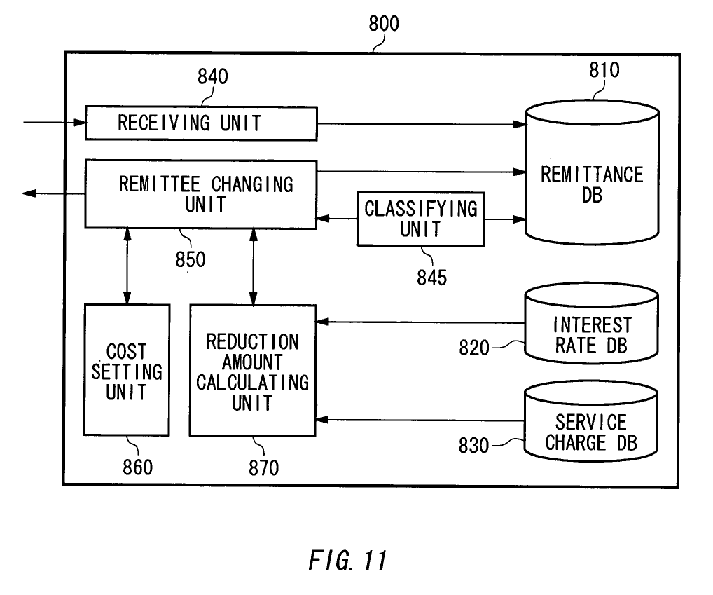

FIG. 11 is the block diagram depicting an example of the configuration of the remittance management system 800. The remittance management system 800 has a remittance database 810, an interest rate database 820 and a service charge database 830, which are databases, and has a receiving part 840, a classifying unit 845, a remittee changing unit 850, a cost setting unit 860 and the reduction amount calculating unit 870, which are functional parts.

The remittance database 810 stores the remittance information of the clients.

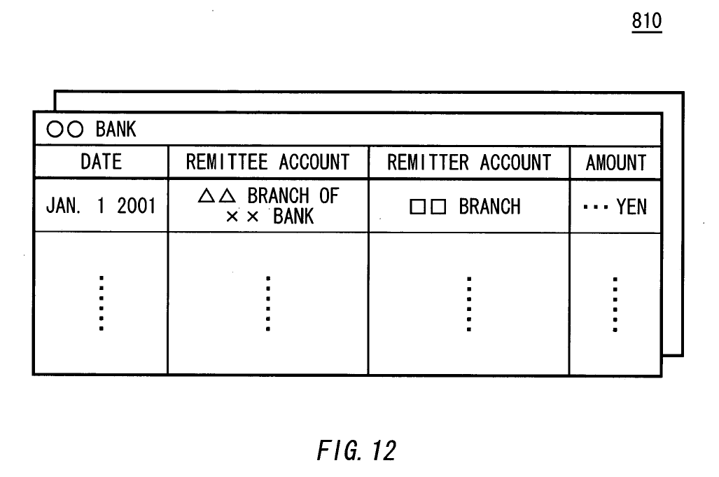

FIG. 12 is an example of the remittance database 810. The remittance database 810 has tables for every bank. Each table has a remittance date field, a remittee account field, a remitter account field and a money amount field. The remittance date field stores the remittance date. The remittee account field stores the account number of the remittee. The remitter account field stores data identifying the remitter account. The money amount field stores an amount of the remitted money. In addition, each remittance can be classified by not only the bank having the remitter account, but the bank having the remittee account.

The interest rate database 820 stores the interest rate by credit.

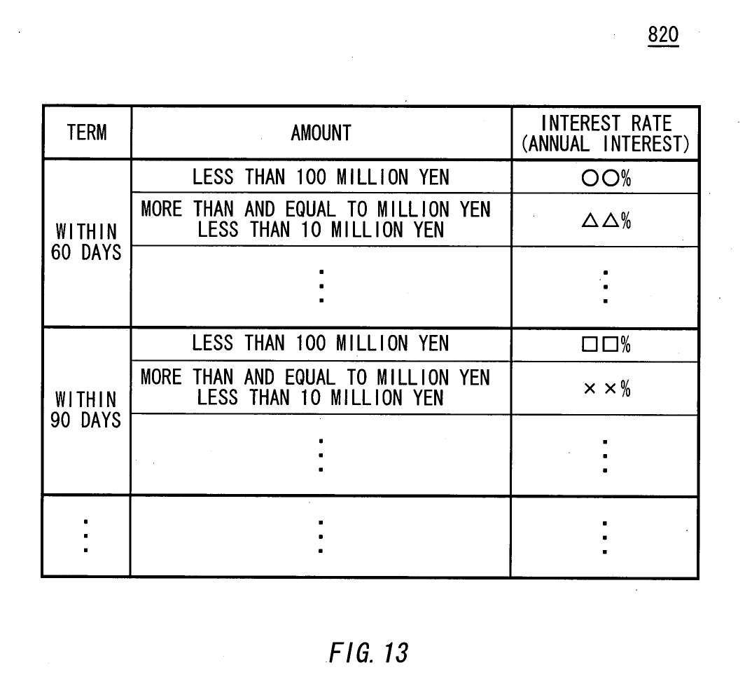

FIG. 13 is an example of the interest rate database 820. The interest rate database 820 manages the interest rate separately according to the credit term and the amount of money.

The service charge database 830 will not be explained since its configuration is similar to that of the service charge database 295 in FIG. 4.

The receiving part 840 receives the information on the remittance from clients from the client terminal 400. The remittance information received by the receiving part 840 includes the data identifying the remittance date, the remittee account, the remitter account and the amount of money. The receiving part 840 stores the received information into the remittance database 810.

The classifying unit 845 classifies the information from the remittance database 810 into a plurality of terms on the basis of the designated date for remittance or the remittance date and sends it to the remittee changing unit 850. Here, the term classified by the classifying unit 845 can be, for example, a week, but the term doesn't need to be always the same.

The remittee changing unit 850 changes the remittees of the remittances, which are classified into the same term by the classifying unit 845, and lowers the remittance service charge. Particularly, the remittee changing unit 850 changes a part or all of the remittance, so that the remittance executed by a bank or banks included in the same group can be getting larger. And, the remittee changing unit 850 sends the information on the remittance of the remittees both before and/or after the change to the reduction amount calculating unit 870 and the cost setting unit 860.

When the cost setting unit 860 receives the information on the remittance from the remittee changing unit 850, it determines the cost for changing the remittees classified as the same term by the classifying unit 845. A method of determining the cost is, for example, to memorize the cost for each remittee change and then multiply the number of times.

The reduction amount calculating unit 870 determines the service charge for changing the remittees of the remittances classified as the same term by the classifying unit 845. Here, the service charge database 830 is used for determining the service charge. That is, the reduction amount calculating unit 870 determines the difference between the sum of the service charge in case of changing the plurality of remittances and the original service charge without changing as the reduction amount. And, the reduction amount calculating unit 870 sends the determined the reduced amount to the remittance composing unit 310.

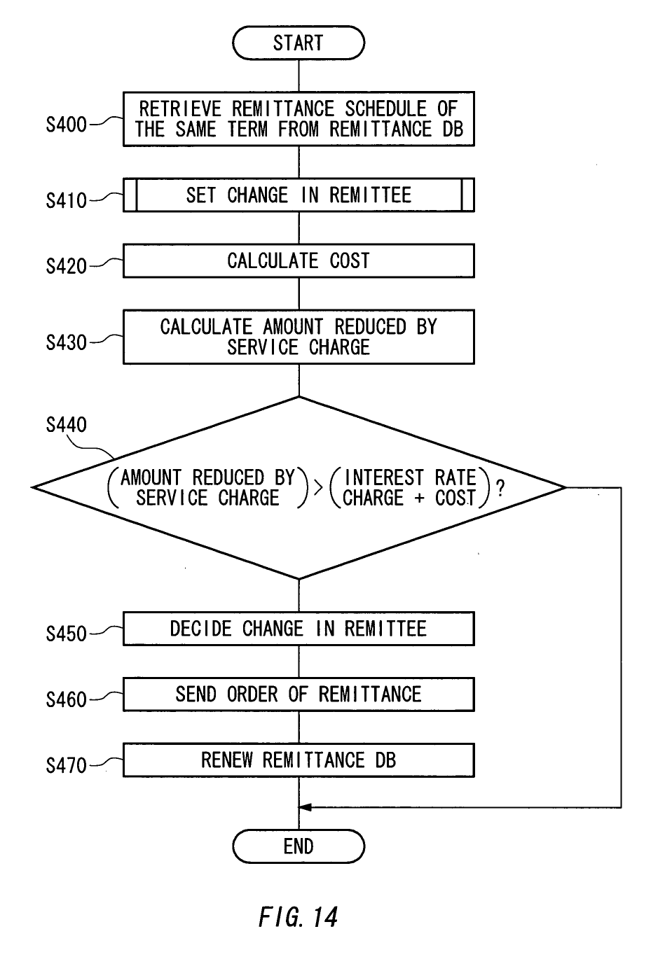

FIG. 14 is the flowchart depicting an example of the process of the remittance management system 800. The remittance management system 800 lowers the remittance service charge by changing the remittee and the amount of the remittance.

The remittance management system 800 extracts the remittance schedule from the remittance database by using the classifying unit 880 and sets the change of the remittee using the remittee changing unit 850 (S410). And, the remittance management system 800 determines the reduced amount of the service charge using the reduction amount calculating unit 870 (S420) and determines the cost using the cost setting unit 860 (S430). And, where the remittee changing unit 850 decides that the reduced amount of the service charge is larger than (S440), the change of the remittee is fixed (S450) and sends the order of the determined remittance to the client terminal 400 (S460) and finishes the process by renewing the remittance database 810 (S470).

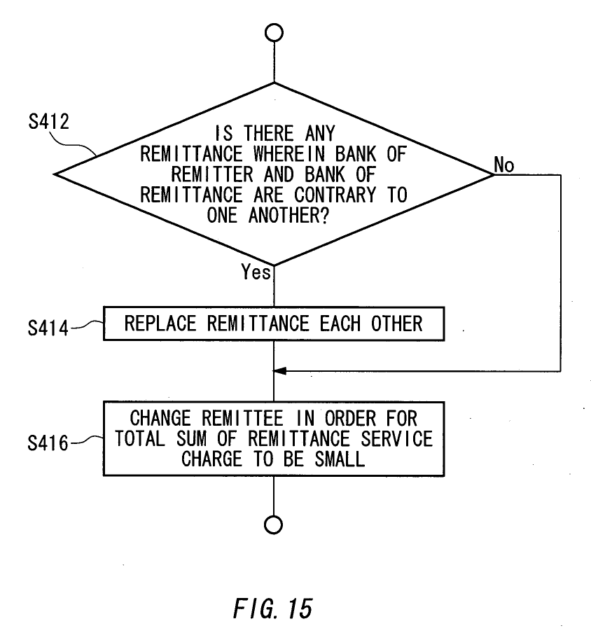

FIG. 15 is the flowchart explaining the process in S410 of FIG. 14 in detail. The remittee changing unit 850 judges whether or not there is a plurality of remittances, wherein the bank having remittee account and the bank having the remitter account are opposite each other (S412). If such remittance exists, the remittee changing unit 850 makes the remittance charge in the same bank large by changing the remittances each other (S414). And, the remittee changing unit 850 changes the remittee so that the total amount of the remittance service charge can be lowered (S416). As an example of the change rule is that the remittee changing unit 850 changes the remittee to enlarge the amount of the remittance in the banks included in the same financial institution.

Accordingly, the amount of the remittance can be lowered by using the remittance management system 800, so that the remittance service charge to be paid for by the clients can also be lowered. And, the burden of the office works accompanying the remittance will be lessened.

And, the explanation of the hardware configuration of the remittance management system 800 will be omitted, since it is similar to that of the remittance management system 200 except the software stored in the recording medium, namely, the software installed in the hard disk driver 710. In addition, the software stored in the recording medium has, as functional components, a receiving module, a classifying module, a remittee changing module, a cost setting module and a reduction amount determination module. The configuration of the CPU 700 in which the modules are installed will not be explained, since its function and configuration are similar to those of the corresponding components of the remittance management system 800, which is an embodiment of this invention.

3. Third Embodiment

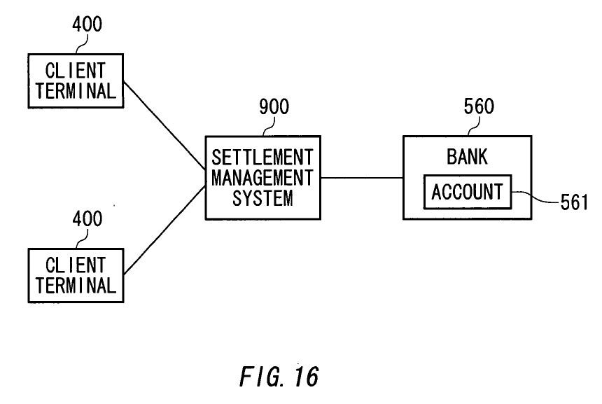

FIG. 16 is the block diagram showing the use of the settlement management system 900 as the third example according to the present invention. In the present embodiment, the settlement management system 900 manages a first account 561 at a bank 560 coupled to a plurality of a client terminal 400 via the Internet (not shown).

The settlement management system 900 manages the amount of deposit to the account 561 at the bank of a part or all of clients managing the client terminal 400 for each client. Moreover, the settlement management system 900 credits the client with the monetary value registered in electrical devices. Here, the monetary value registered in electrical devices may be credited according to the amount of deposit to the account 561 or credited without any proof of cash. Furthermore, the settlement management system 900 receives the order of the settlement for other client and reduces the monetary value registered in electrical devices of the client according to the order, while adding to the monetary value registered in electrical devices of other client. Moreover, the settlement management system 900 orders the account 561 of the bank 560 to remit money equivalent to monetary value registered in electrical devices, while making the amount of deposit of the client zero. There can be a plurality of banks 560.

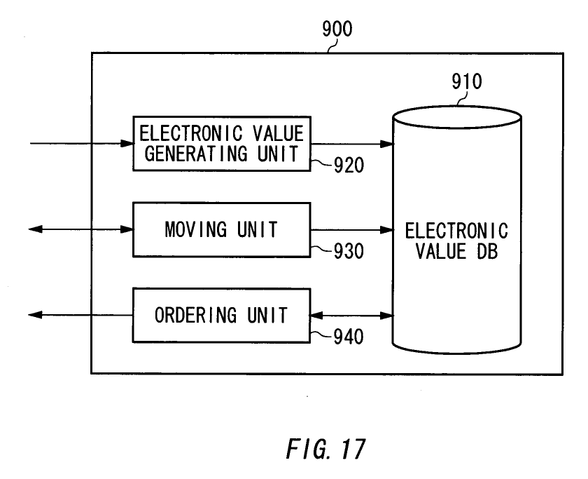

FIG. 17 is the block diagram depicting the components of the settlement management system 900. The settlement management system 900 is a monetary value registered in electrical devices database 910, a monetary value registered in electrical devices generating unit 920, a moving unit 930, and an ordering unit 940.

The monetary value registered in electrical devices database 910 stores the information on the remittance, namely, the deposit and withdrawal of clients.

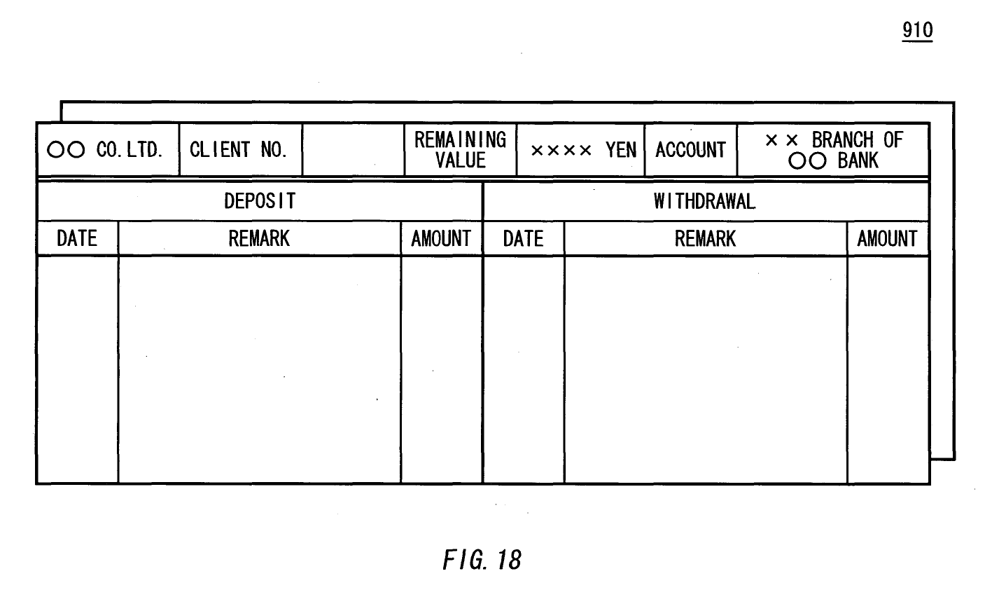

FIG. 18 shows an example of the monetary value registered in electrical devices database 910. The monetary value registered in electrical devices database 910 has tables for each client. Each table has a client name field, a client number field, a value remainder field, an account field, a deposit field and a withdrawal field.

A value remainder field stores the remainder of the monetary value registered in electrical devices of clients. And, when there is an order to remit money to other client from the client terminal 400, the amount of money stored in the value remainder field is diminished by the sum of the amount of remittance and the decided amount of service charge. In the meantime, if there is an order to remit money from the other client to the client, the amount of money stored in the value remainder field is added by the amount of the deposit.

The account field stores the information identifying the account of clients, for examples, the name of the bank, the name of the branch and the account number.

Both the deposit field and the withdrawal field have a date field, a client field and a money amount field. The date field stores information identifying the date when the settlement order is made. The client field stores the information identifying the settlement ordering source or the settlement ordered source. The money amount field stores the amount of deposit or withdrawal of the monetary value registered in electrical devices to be ordered.

Returning to FIG. 17, the monetary value registered in electrical devices generating unit 920 generates, if there is a deposit from the bank 560 to the account 561, the monetary value registered in electrical devices corresponding to the deposit, while receiving the information identifying the amount of deposit and storing the date of deposit and the deposit source in the monetary value registered in electrical devices database 910. And, the monetary value registered in electrical devices generating unit 920 can generate the monetary value registered in electrical devices, if there is an order from exterior part, without any proof of deposit.

The moving unit 930 renews the monetary value registered in electrical devices database 910 according to the received settlement order, after receiving the settlement order from the client terminal 400. Particularly, the moving unit 930 subtracts the monetary value registered in electrical devices from the value remainder field of the settlement ordering source by the sum of the ordered settlement amount and a predetermined service charge, while adding the monetary value registered in electrical devices to the value remainder field of the settlement ordered source. And, the moving unit 930 stores the information identifying the date and the settlement ordered source and the ordered amount of the settlement in the remittance field of the settlement ordering source, while storing the information identifying the date and the settlement ordering source and the ordered amount of the settlement in the remittance field of the settlement ordered source.

And, the moving unit 930, when the renewal of the monetary value registered in electrical devices database 910i is finished, sends the information representing the finish of the settlement to the client terminal 400.

The ordering unit 940 orders the account 561 of the bank 560 to remit money equivalent to the monetary value registered in electrical devices stored in the value remainder field with respect to at least a part of the clients at a predetermined time.

The ordering unit 940 makes the value remainder field of the client zero, when receiving the information representing that the remittance has been done ordered by the bank 560. Here, the predetermined time can be established at regular intervals or established by the clients.

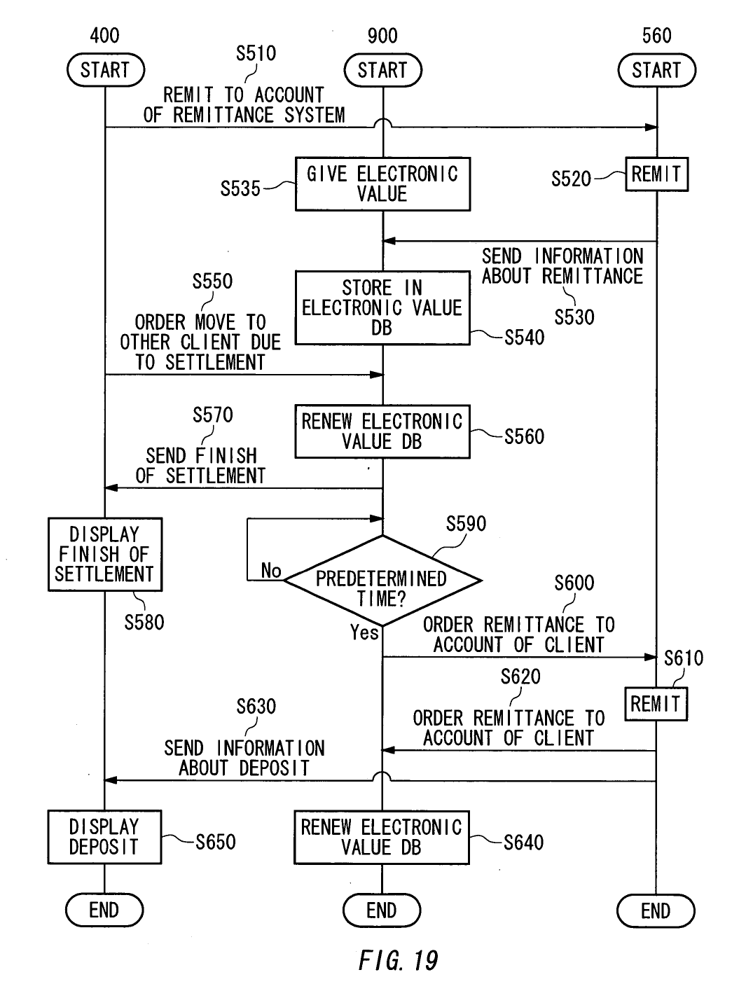

FIG. 19 is the flowchart demonstrating an example of process of the settlement management system 900.

Where the client terminal 400 orders the remittance to the account 561 managed by the settlement management system 900 (S510), the bank 560 remits money to the account 561, while sending the information identifying the amount of remittance and the remitting source to the monetary value registered in electrical devices generating unit 920 of the settlement management system 900 (S530). When the monetary value registered in electrical devices generating unit 920 receives the information identifying the remittance, the amount of the remittance and the remittance source from the bank 560, it credits the client with the monetary value registered in electrical devices (S535) and stores the monetary value registered in electrical devices and the received information in the monetary value registered in electrical devices database 910 with (S540).

And, the moving unit 930 of the settlement management system 900 receives a settlement order toward other client from the client terminal 400 (S550), renews the monetary value registered in electrical devices database 910 according to the received settlement order (S560) and sends the information representing the settlement completion (S570).

When the client terminal 400 receives the information representing the settlement completion from the moving unit 930, it displays the settlement completion (S580).

And, the ordering unit 940 of the settlement management system 900 orders at least a part of the clients to remit money equivalent to the monetary value registered in electrical devices stored in the value remainder field to the account 561 of the bank 560 at a predetermined time (S590 and S600).

When the account 561 receives the remittance order from the ordering unit 940, it remits money to the client according to the remittance order (S610), while sending the information on the remittance to the settlement management system 900 and the client terminal 400 (S620 and S630). Here, the information on the remittance includes at least the amount of the remittance and the remitting source.

When the ordering unit 940 of the settlement management system 900 receives the information representing the remittance from the bank, it renews the monetary value registered in electrical devices database 910 (S640) by making the value remainder field of the client to be remitted zero.

When the client terminal 400 receives the information representing the deposit from the bank 560, it displays the deposit (S650).

Accordingly, the amount of the remittance can be lowered by using the remittance management system 900, so that the remittance service charge to be paid for by the clients can also be lowered. And, the burden of the office works accompanying the remittance will be lessened.

And, the explanation of the hardware configuration of the remittance management system 900 will be omitted, since it is similar to that of the remittance management system 200 except the software stored in a recording medium, namely, the software installed in the hard disk driver 710. In addition, the software stored in the recording medium has, as functional components, a monetary value registered in electrical devices generating module, a moving module and a remittance ordering module. The configuration of the CPU 700 in which the modules are installed will not be explained, since its function and configuration are similar to those of the corresponding components of the remittance management system 900, which is an embodiment of this invention.

4. Fourth Embodiment

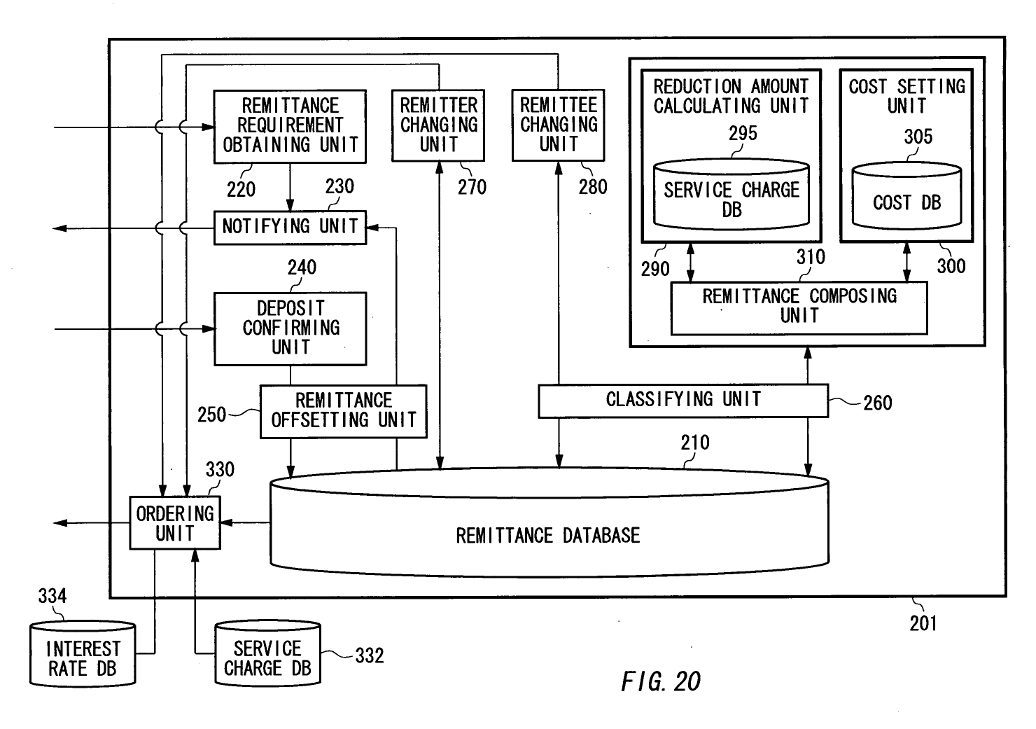

FIG. 20 is the block diagram showing the schematic configuration of the remittance management system 201 as the fourth example of the present invention.

The remittance management system 201, though not shown, like the remittance management system 200 as the first embodiment, manages the first account 501 at the first bank 500 as a financial institution, the second account 521 at the second bank 520 and the third account 541 at the third bank 540 coupled to the client terminal 400 via the Internet 10.

The configuration and the function of the remittance management system 201 is substantially similar to those of the remittance management system 200 except that the service charge database 332 and the interest charge database 334 are added and the function of the ordering unit 330 further extends.

The configuration of the service charge database 332 will not be described in detail, because it is substantially similar to that of the service charge database 295 shown in FIG. 4. That is, the service charge database 332 may be included in the service charge database 295.

The interest rate database 334 stores various the interest rates such as the loan interest rate, the deposit interest rate in regard to a plurality of financial institution at which a plurality of accounts exist managed by the remittance management system 201.

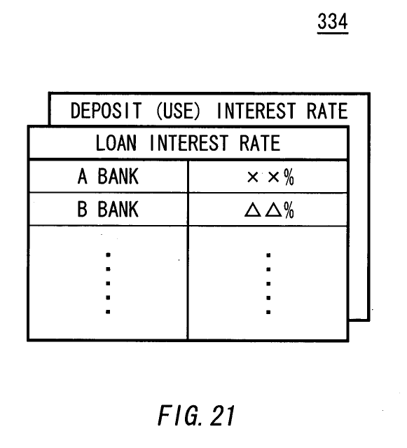

FIG. 21 shows an example of the configuration of the interest rate database 334. In the present embodiment, the interest rate database 334 has the loan interest rate table and the deposit interest rate table. The loan interest rate table stores the loan interest rate for each bank. The deposit interest rate table the deposit interest rate for each bank.

The ordering unit 330, if the deposit amount of the second account 521 is insufficient for the amount of the remittance to the remittee account 522, orders to supply money so that the supply cost can be cheapest using the service charge database 332 and the interest rate database 334. Moreover, the ordering unit 330 has the same function as the remittance management system 200.

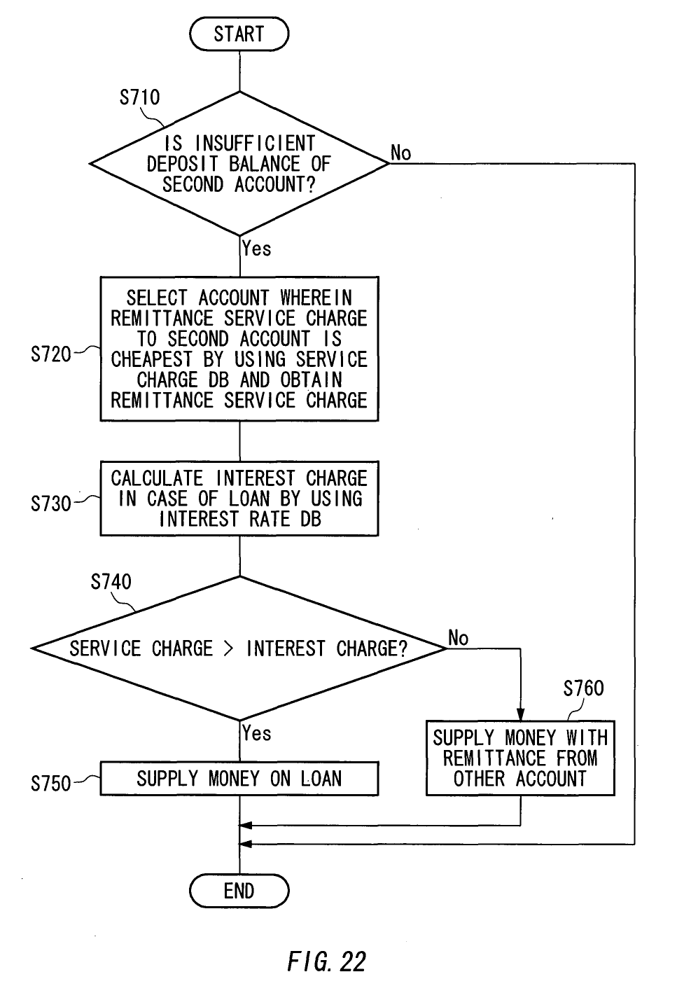

FIG. 22 is the flowchart showing an example of the process of the ordering unit 330.

The ordering unit 330, if the deposit amount of the second account 521 is insufficient for the amount of the remittance to the remittee account 522 (S710), selects an account, of which the remittance service charge to the second account 521 is cheapest among the accounts managed by the remittance management system 201, using the service charge database 332 and obtains the remittance service charge (S720). Moreover, the ordering unit 330 calculates the interest charge for the loan in the second account 521 using the interest rate and the loan scheduled term stored in the interest rate database 334 (S730).

Then, the ordering unit 330, if the obtained remittance service charge is larger than the calculated interest charge (S740), orders the second account 521 to supply money on loan (S750), or if the obtained remittance service charge is less than the calculated interest charge (S740), orders the account selected in the step S720 to remit money to the second account 521 (S760).

Moreover, the ordering unit 330 judges that the remittance from the first account 501 or the third account 541 directly to the remittee account 522 is cheapest, if the deposit amount of the second account 521 is insufficient for the amount of the remittance to the remittee account 522, and then it orders the first account 501 or the third account 541 to remit money to the remittee account 522.

Therefore, according to the remittance management system 201, it is possible to prevent the cost to be paid for by the administrator of the remittance management system 201 from increasing.

Next, the hardware configuration of the remittance management system 201 will not be described, because it is the same as that of the remittance management system 200 shown in FIG. 9 except the software provided being stored in the recording medium, namely, the software installed in the hard disk driver 710. Moreover, the software provided being stored in the recording medium, namely, the software installed in hard disk driver 710 includes a remittance requirement obtaining module, a notifying module, a deposit confirming module, a remittance off setting module, a classifying module, a remitter changing module, a remittee changing module, a reduction amount calculating module, a cost setting module, a remittance composing module and a remittance ordering module. The process, which these modules allows the CPU 700 to perform, with respect to the remittance management system 201 according to the present embodiments will not be described, because it is similar to the function and the process of the corresponding units.

5. Fifth Embodiment

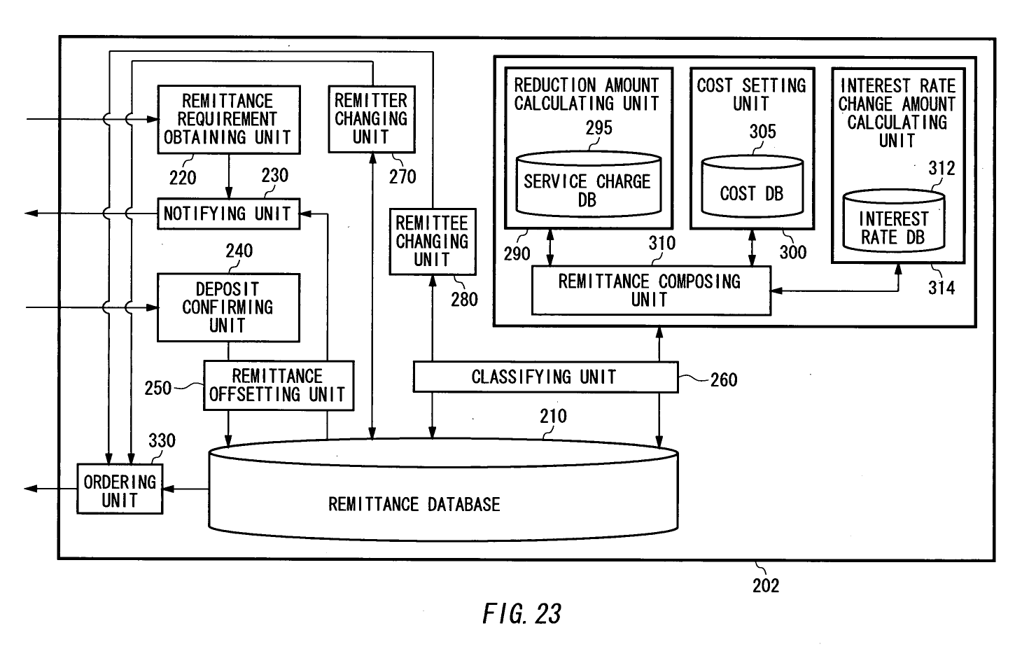

FIG. 23 shows the schematic configuration of the remittance management system 202 as the fifth example of the present invention.

The remittance management system 202, though not shown, like the remittance management system 200 as the first embodiment, manages the first account 501 at the first bank 500 as a financial institution, the second account 521 at the second bank 520 and the third account 541 at the third bank 540 coupled to the client terminal 400 via the Internet 10.

The configuration and the function of the remittance management system 202 is substantially similar to those of the remittance management system 200 except that the interest rate database 312 and an interest deviation calculating unit 314 are added and the function of the remittance composing unit 310 is different.

The interest rate database 312 stores various the interest rates such as the loan interest rate, the deposit interest rate in regard to a plurality of financial institution at which a plurality of accounts exist managed by the remittance management system 202. The specific configuration of the interest rate database 312 will not be described in detail, because it is substantially similar to the interest rate database 334 of the remittance management system 201 illustrated in FIG. 21.

The interest deviation calculating unit 314, if there is a plurality of remittances from the second account 521 to the remittee account 522 among the remittances classified as the same term by the classifying unit 260, calculates the deviation of the interest rate for adjusting the plurality of remittances to one remittance using the interest rate database 312.

Particularly, if a plurality of remittances, of which the remittance designation dates are different from each other, from the second account 521 to the remittee account 522, there is a difference of the deposit interest charge between the case of adjusting to one remittance and not due to the difference of the deposit terms. Here, if the deposit balance of the second account 521 performs loan less than the amount of the remittance, there is a difference of the interest charge due to the loan interest charge in addition to the deposit interest charge. The interest deviation calculating unit 314 calculates such difference using the interest rate database 312, the difference of the deposit terms and the loan scheduled term.

The remittance composing unit 310 compares the reduced amount calculated by the reduction amount calculating unit 290 to the sum of the deviation of the interest rate calculated by the interest deviation calculating unit 314 and the cost calculated by the reduction amount calculating unit, and it renews the remittance database 210, if the reduced amount is larger, by adjusting a plurality of remittances to one remittance.

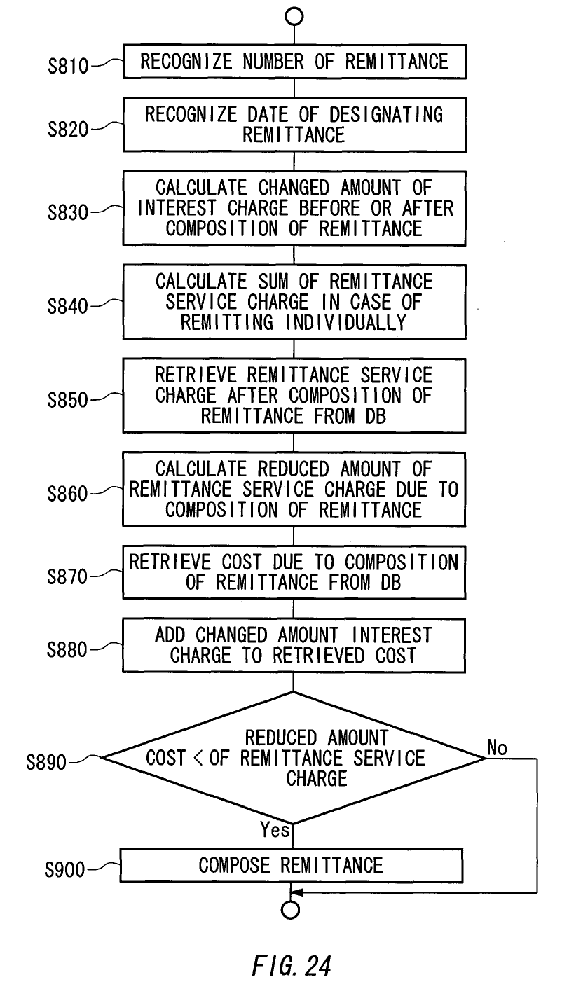

FIG. 24 is the flowchart showing an example of the detailed process of the remittance management system 202 corresponding to the step S200 shown in FIG. 7 in regard to the remittance management system 200.

First, the remittance management system 202 recognizes the number of the remittance to be composed, namely, the number of the remittance from the second account 521 to the remittee account 522 classified as the same term (S810). Then, the remittance management system 202 recognizes the remittance designation dates of each remittance (S820) and calculates the deviation of the interest rate caused by the remittance composition using the reduction amount calculating unit 290 (S830). Then, the remittance management system 202 calculates the sum of the remittance service charges for remitting money separately using the reduction amount calculating unit 290 (S840), while calculating the remittance service charge for composing the remittance (S850), and it calculates the reduced amount of the remittance service charge due to the remittance composition by calculating the difference (S860).

Next, the remittance management system 202 retrieves the cost for the remittance composition from the cost database 305 using the cost setting unit 300 (S250).

Then, the remittance management system 202 compares the cost to which the deviation of the interest rate is added (S880) to the reduced amount of the remittance service charge using the remittance composing unit 310 (S890). If the reduced amount of the remittance service charge is larger than the cost, the remittance management system 202 composes the plurality of remittances to one remittance (S900) and renew the remittance database 210 according to the composition.

Therefore, according to the remittance management system 202, it is possible to prevent the cost to be paid for by the administrator of the remittance management system 202 from increasing.

Next, the hardware configuration of the remittance management system 202 will not be described, because it is the same as that of the remittance management system 200 shown in FIG. 9 except the software provided being stored in the recording medium, namely, the software installed in the hard disk driver 710. Moreover, the software provided being stored in the recording medium, namely, the software installed in hard disk driver 710 includes a remittance requirement obtaining module, a notifying module, a deposit confirming module, a remittance off setting module, a classifying module, a remitter changing module, a remittee changing module, a reduction amount calculating module, a cost setting module, a remittance composing module and a remittance ordering module. The process, which these modules allows the CPU 700 to perform, with respect to the remittance management system 202 according to the present embodiments will not be described, because it is similar to the function and the process of the corresponding units.

According to the present invention, it is possible to reduce the burden of the work or the remittance service charge in remitting money via banks.

Although the present invention has been described by way of exemplary embodiments, it should be understood that those skilled in the art might make many changes and substitutions without departing from the spirit and the scope of the present invention which is defined only by the appended claims.

For example, the first account 521 of the remittance management system 200 may have the prepayment function. In this case, if there is a remittance from the first account 501 to the remitter account 501, the amount of the prepayment may be increased without the remittance. That is, the remittance offsetting unit 250 is not needed.

What is claimed is:

1. A remittance management system for managing a deposit and/or a withdrawal in regard to accounts at a plurality of financial institutions, while managing a remittance performed by a client from a remitter account at a first financial institution to a remittee account at a second financial institution, said remittance management system comprising:
a deposit confirming unit for confirming that money has been transferred from said remitter account to said first account at said first financial institution managed by said remittance management system; and
a remitter changing unit for changing said remitter by ordering to remit money from said second account at said second financial institution managed by said remittance management system to said remittee account instead of a remittance from said first account to said remittee account caused by a deposit to said first account.

2. A remittance management system as claimed in claim 1, further comprising a notifying unit for notifying said client of remitting money from said remitter account to said first account, wherein said client desires to remit money from said remitter account at said first financial institution to said remittee account at said second financial institution.

3. A remittance management system as claimed in claim 1, further comprising a remittee changing unit for increasing an amount of said remittance between said first account and said second account by changing a part or all of a remittance from said second account to said first account and a part or all of a remittance from said first account to said remitter account each other,
wherein said deposit confirming unit further manages a deposit to said second account, and
said remitter changing unit further orders to remit money from said first account to said remittee account instead of a remittance from said second account to said remitter account caused by a deposit to said second account.

4. A remittance management system as claimed in claim 3, further comprising a classifying unit for classifying remittances according to terms taking a remittance designation date or a remittance due date for a criterion,
wherein said remittee changing unit changes a remittance classified as the same term by said classifying unit.

5. A remittance management system as claimed in claim 1, further comprising:
a service charge database for storing a remittance service charge in regard to said plurality of financial institutions;
a reduction amount calculating unit for calculating a reduced amount of said remittance service charge in case a plurality of remittances is adjusted to one remittance using said service charge database;
a cost setting unit for calculating a cost for adjusting said plurality of remittances to one remittance using said service charge database; and
a remittance composing unit for comparing said reduced amount of said remittance service charge to said cost and for adjusting said plurality of remittances to a single remittance when said reduced amount of said remittance service charge is more than said cost.

6. A remittance management system as claimed in claim 1, further comprising:
an interest rate database for storing a loan interest rate and a deposit interest rate of said plurality of financial institutions;
a service charge database for storing a remittance service charge in regard to said plurality of financial institutions;
a reduction amount calculating unit for calculating a reduced amount of said remittance service charge in case a plurality of remittances, of which said remittance designation dates are different from each other, is adjusted to one remittance using said service charge database;
an interest deviation calculating unit for calculating a deviation of an interest rate caused by adjusting said plurality of remittances to said one remittance using said interest rate database;
a cost setting unit for calculating a cost for adjusting said plurality of remittances to one remittance using said service charge database; and
a remittance composing unit for comparing said reduced amount of said remittance service charge to said cost based on said deviation of the interest rate and for adjusting said plurality of remittances to a single remittance when said reduced amount of said remittance service charge is more than said cost.

7. A remittance management system as claimed in claim 5 or claim 6, further comprising a notifying unit for notifying and confirming said client of adjusting said plurality of remittances to said one remittance.

8. A remittance management system as claimed in claim 5 or claim 6, further comprising a notifying unit for allowing said client to recognize a result of comparing said reduced amount of said remittance service charge to said cost,
wherein said remittance composing unit adjusts said plurality of remittances to said one remittance, after receiving an order to adjust said plurality of remittances to said one remittance from said client.

9. A remittance management system as claimed in claim 1, further comprising:
an interest rate database for storing a loan interest rate and a deposit interest rate of said plurality of financial institutions;
a service charge database for storing a remittance service charge in regard to said plurality of financial institutions; and
a ordering unit for ordering said accounts at said plurality of financial institutions to supply money so that a cost for supplying money can be minimized using said interest rate database and said service charge database, in case a deposit balance of said second account is insufficient for a remittance amount to said remittee account.

10. A remittance management system as claimed in claim 9, wherein said ordering unit selects an account, of which said remittance service charge from other said account to said second account is cheapest, and
orders said selected account to remit money to said second account, in case said remittance service charge from said selected account to said second account is lower than an interest charge for a loan in said second account, or
orders said second account to borrow, in case said remittance service charge from said selected account to said second account is higher than or equal to said interest charge for said loan in said second account.

11. A remittance management system as claimed in claim 1, further comprising a remittance offsetting unit for offsetting a deposit amount from said remitter account to said first account by a remittance amount from said account managed by said remittance management system to said remitter account,
wherein said deposit confirming unit manages said remittance from said account managed by said remittance management system to said remitter account.

12. A remittance management system for managing remittances between at least two financial institutions, comprising:
a remittance database for managing a remitter financial institution at which a remitter account exists, a remittee financial institution at which a remittee account exists and an amount of said remittance for each remittance;
a service charge database for storing remittance service charge data in regard to within the same financial institution and between different financial institutions; and
a remittee changing unit for changing remittees of a plurality of remittances in regard to at least a part of said amount of said remittance so that a total amount of said remittance service charge can be lowered.

13. A remittance management system as claimed in claim 1, wherein said remittee changing unit increases said amount of said remittance in said remitter financial institution by changing a part or all of a remittance to said remitter financial institution and a part or all of a remittance from said remitter financial institution each other, in case there is a remittance to said remitter financial institution each other.

14. A remittance management system as claimed in claim 13, further comprising a classifying unit for classifying remittances according to terms taking a remittance designation date for a criterion,
wherein said remittee changing unit changes remittees of a plurality of remittances classified as the same term by said classifying unit.

15. A remittance management system as claimed in claim 13, further comprising:
a reduction amount calculating unit for calculating a reduced amount of said remittance service charge in case remittees of two of remittances, of which said remittance designation dates are different from each other, are changed each other;
an interest deviation calculating unit for calculating an interest charge for changing said remittees of two of remittances each other; and
a cost setting unit for calculating a cost for changing said remittees of two of remittances each other;
wherein said remittee changing unit changes said two remittees each other, in case of judging that said reduced amount of said remittance service charge is more than a sum of said interest charge and said cost.

16. A settlement management system for managing a settlement of a client, comprising:
a monetary value registered in electrical devices generating unit for crediting said client with a monetary value registered in electrical devices, in case there is proof of cash and a deposit or in case there is no proof of cash and a deposit;
a monetary value registered in electrical devices database for managing said monetary value registered in electrical devices for each client; and
an moving unit for allowing said client to settle a debt by moving said monetary value registered in electrical devices of said client managed by said monetary value registered in electrical devices database to other client according to an order of said client.

17. A remittance management method for managing a remittance from a remitter account at a first financial institution to a remittee account at a second financial institution, comprising the steps of:
confirming that money has been transferred from said remitter account to said first account at said first financial institution managed by a remittance management system; and
remitting money from said second account at said second financial institution to said remittee account and notifying said client of a result of said remittance, instead of a remittance from said first account to said remittee account caused by a deposit to said first account.

18. A remittance management method for managing remittances between at least two financial institutions, comprising the steps of:
managing remittance service charge data in regard to within the same financial institution and between different financial institutions;
managing a remitter financial institution at which a remitter account exists, a remittee financial institution at which a remittee account exists and an amount of said remittance for each remittance; and
changing remittees of a plurality of remittances in regard to at least a part of said amount of said remittance so that a total amount of said remittance service charge can be lowered, finishing said remittance and notifying said client of a result of said remittance.

19. A settlement management method for managing a settlement of a client, comprising the steps of:
crediting said client with a monetary value registered in electrical devices, both in case there is proof of cash and in case there is no proof of cash;
managing said monetary value registered in electrical devices for each client;
allowing said client to settle a debt by moving said managed monetary value registered in electrical devices of said client to other client according to an order of said client; and
notifying said client of the finish of said settlement.

20. A computer program for managing a remittance performed by a client from a remitter account at a first financial institution to a remittee account at a second financial institution, comprising:
a deposit confirming module for confirming that money has been transferred from said remitter account to said first account at said first financial institution managed by a remittance management system; and
a remitter changing module for changing said remitter by ordering to remit money from said second account to said remittee account instead of a remittance from said first account to said remittee account caused by a deposit to said first account.

21. A computer program for managing remittances between at least two financial institutions, comprising:
a remittance managing module for managing a remitter financial institution at which a remitter account exists, a remittee financial institution at which a remittee account exists and an amount of said remittance for each remittance; and
a remittee changing module for changing remittees of a plurality of remittances in regard to at least a part of said amount of said remittance so that a total amount of said remittance service charge can be lowered.

22. A computer program for managing a settlement of a client, comprising:
a monetary value registered in electrical devices generating module for crediting said client with a monetary value registered in electrical devices, both in case there is proof of cash and in case there is no proof of cash; and
an moving module for allowing said client to settle a debt by moving said monetary value registered in electrical devices of said client to other client according to an order of said client.
